(19) United States
(12) Patent Application Publication
(10) Pub. No.: US 2010/0072328 A1
(43) Pub. Date: Mar. 25, 2010

(54) QUICK MOUNT ANCHOR SYSTEM

(75) Inventors: Richard BURNHAM, Gloucester, MA (US); Patrick MOONEY, Peabody, MA (US)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: ITT MANUFACTURING ENTERPRISES, INC., Wilmington, DE (US)

(21) Appl. No.: 12/234,069

(22) Filed: Sep. 19, 2008

(51) Int. Cl. F16L 3/06

(52) U.S. Cl. 248/49; 403/361

(57) ABSTRACT

An anchor system is provided featuring a two-piece toggle having a conduit with a passage in-between for passing one or more wires through, and having one end with a crosspiece formed thereon for passing through an aperture in a mounting surface of another device and engaging one side of the mounting surface and a fastener for frictionally coupling the two-piece toggle to an opposing side of the mounting surface of the other device so as to hold or secure the two-piece toggle in relation to the other device.

### BACKGROUND OF THE INVENTION

1. Field of the Invention

The present invention relates to a mounting system; and more particularly relates to a mounting system for mounting an electrical device.

2. Description of Related Art

Mounting systems are known and include: U.S. Pat. No. 4,880,387, which shows a device for mounting on a junction box, and having a conduit for passing wires through and threading onto a connector attached to a mounting surface. Other known patents show other toggle or molly-like arrangements, including U.S. Pat. No. 1,111,657 which typifies a large body of art showing split threaded bolts; U.S. Pat. No. 2,072,066 which discloses a split threaded member having toggles for securing the same in place; U.S. Pat. Nos. 3,534,650 and 4,457,653 which disclose a threaded member held in place with a toggle and means for securing a hook member in place; and U.S. Pat. Nos. 832,920; 883,833 and 3,212,224 which disclose other detachable fastening devices, including a fishing tool for wells. However, none of these known patents disclose a mounting system having a conduit having passageway with electrical wires for mounting an electrical device.

### SUMMARY OF THE INVENTION

The present invention provides a new and unique anchor system featuring a two-piece toggle having a crosspiece portion on one end configured to pass through an aperture in a mounting surface and engage one side of the mounting surface, and also having a stud portion on its other end configured to form a conduit to pass one or more wires through the mounting surface; and a fastener configured to couple the stud portion to the mounting surface on an opposing side thereof so as to urge the crosspiece portion against the one side of the mounting surface and lock the anchor system to the mounting surface.

According to some embodiments of the present invention, the anchor system may include one or more of the features, as follows:

The two-piece toggle may also feature a first L-shaped toggle half having an L-shaped portion configured for inserting into the aperture in the mounting surface so that the L-shaped portion extends in one direction along the mounting surface, and having a stud-like portion extending from the other side of the mounting surface; and a second L-shaped toggle half having a corresponding L-shaped portion also configured for inserting into the aperture so that the corresponding L-shaped portion extends in another direction along the mounting surface, and having a corresponding stud-like portion extending from the other side of the mounting surface; where the first and second L-shaped toggle halves are configured for mating together so as to form the anchor system having the crosspiece portion formed by first and second L-shaped portions on the one side of the mounting surface, and having the stud portion formed by respective stud-like portions on the other side of the mounting surface.

The crosspiece portion may include a toggle wing pivotally arranged on a toggle pin on the one end and configured to pass through the aperture, the crosspiece portion also having left and right toggle wing portions configured to extend in opposite directions on the one side of the mounting surface after the toggle wing is inserted in the aperture and tilts or rotates 90°.

The toggle wing may be substantially pivoted at its center so as to form the crosspiece portion on the one side of the mounting surface once it rotates substantially 90°.

The stud portion may include threads configured on its outer surface for receiving the fastener having corresponding threads for engaging the threads of the stud portion.

The stud portion may also be configured to couple or mount a device thereto, including a light, a speaker, an antenna, etc.

The mounting surface may include tubing, a flat wall, a ceiling or a T-top that forms part of some other device, structure, vehicle, equipment, or other apparatus either now known or later developed in the future.

The present invention may also take the form of a method featuring inserting an L-shaped portion of a first L-shaped toggle half into an aperture in a mounting surface so that the L-shaped portion extends in one direction on one side of the mounting surface, and a stud-like portion extends from the other side of the mounting surface; inserting a corresponding L-shaped portion of a second L-shaped toggle half into the aperture so that the corresponding L-shaped portion extends in another direction on the one side of the mounting surface, and a corresponding stud-like portion extends from the other side of the mounting surface; mating together the second L-shaped toggle half and the first L-shaped toggle half so as to form an anchor system having a crosspiece portion formed by two L-shaped portions on one side of the mounting surface and a stud portion formed by respective stud-like portions on the other side of the mounting surface; and attaching a fastener to the stud portion so as to urge the crosspiece portion against the one side of the mounting surface and lock the anchor system to the mounting surface.

According to some embodiments of the present invention, this method may include one or more of the features, as follows:

The method may include configuring the stud portion so as to form a conduit to pass one or more wires through the mounting surface.

Each L-shaped toggle half may be formed as an integral molded piece.

Each L-shaped toggle half may be made of plastic, aluminum, stainless steel, fiberglass, or other suitable material.

Each stud-like portion may have a respective partial threaded portion configured to form a threaded portion when the first L-shaped toggle half and the second L-shaped toggle half are mated to form the anchor system for receiving a corresponding fastener having corresponding threads.

The two L-shaped portions may extend in substantially opposite directions.

The method may include inserting one or more wires into a conduit portion of the first L-shaped toggle half before inserting the first L-shaped toggle half into the aperture for subsequently coupling to an electrical device to be mounted onto the stud portion.

The first L-shaped toggle half may have a respective stud portion with a partial tubular portion, an intermediate annular portion, or both for passing the one or more wires through in order to retain the same in the first L-shaped toggle half.

Each L-shaped toggle half may have a respective curved portion where each stud portion is connected to each L-shaped portion configured to facilitate inserting each L-shaped portion into the aperture.

The method may include inserting one or more washers onto the stud portion so as to be arranged between the fastener and the mounting surface.

The method may include providing a protective boot over some or all of the fastener for sealing and protecting the mounting anchor exposed on the outside of the mounting surface.

Each L-shaped toggle half has its respective stud portion connected to and extending substantially at a right angle in relation to its L-shaped portion.

The present invention may also take the form of a method featuring inserting one end of an anchor system having a toggle wing portion into an aperture of a mounting surface, the toggle wing portion having a toggle wing pivotally arranged by a toggle pin; disturbing the anchor system so that the toggle wing rotates substantially 90° and part of its longitudinal surface rests on one side of the mounting surface so as to form a crosspiece portion; and attaching a fastener to a stud portion on the other side of the mounting surface so as to urge the crosspiece portion against the mounting surface and lock the anchor system to the mounting surface.

According to some embodiments of the present invention, this method may include one or more of the features, as follows: The toggle wing may be substantially pivoted at its center so as to form the crosspiece portion on the one side of the mounting surface once it rotates substantially 90°. The stud portion may be configured to form a conduit to pass one or more wires through the mounting surface. The toggle wing portion and the stud portion may be made of plastic, aluminum, stainless steel, fiberglass, or other suitable material.

The present invention may also take the form of a kit for over-the-counter sales of the anchor system disclosed herein. For example, the kit may comprise: a first L-shaped toggle half having an L-shaped portion configured to insert into an aperture in a mounting surface so that the L-shaped portion extends in one direction on one side of the mounting surface and a stud-like portion extends from the other side of the mounting surface; a second L-shaped toggle half having a corresponding L-shaped portion configured to insert into the aperture so that the corresponding L-shaped portion extends in another direction on the one side of the mounting surface and a corresponding stud-like portion extends from the other side of the mounting surface; the first L-shaped toggle half and the second L-shaped toggle half being configured to mate together so as to form an anchor system having a crosspiece portion formed by two L-shaped portions on the one side of the mounting surface and a stud portion formed by respective stud-like portions on the other side of the mounting surface; a fastener configured to attach to the stud portion so as to urge the crosspiece portion against the one side of the mounting surface and lock the anchor system to the mounting surface; and a set of instructions for informing a purchaser of the kit how to assemble the anchor system.

Advantages of the mounting system according to some embodiments of the present invention include:
The mounting system may be a blind toggle anchor that exposes a strongly anchored stud to mount or clamp devices to.
One embodiment, sometimes referred to as the hollow version, can cleanly hide-away wires for mounting any type of electronic device like: lights, speakers, antennas, radar, etc.
Another embodiment, sometimes referred to as the solid version, can rigidly blind mount anything using a stud and a nut to clamp it. (Boat seats, fishing pulpits, etc.)
The large wing design allows the mounting system to be mounted to many surfaces: tubing, flat walls made of all materials: aluminum, fiberglass, plastic, wood, wallboard, etc. (Ideal for Boats and RV's)
The split toggle design makes it easy to remove so it is reusable.
It also requires drilling a smaller aperture than typical anchors.
Design has the strength to mount heavy items on many surfaces.

### BRIEF DESCRIPTION OF THE DRAWING

The drawing includes the following Figures, which are not necessarily drawn to scale:

FIG. 1a shows a first toggle half having wires inserted therein according to some embodiments of a quick mount anchor system of the present invention.

FIG. 1b shows the first toggle half in FIG. 1a partially inserted into a aperture in tubing according to some embodiments of the quick mount anchor system of the present invention.

FIG. 1c shows a second toggle half in FIG. 1a partially inserted into the aperture in tubing in FIG. 1b in front of the first toggle half according to some embodiments of the quick mount anchor system of the present invention.

FIG. 1d shows washers and a screw nut for inserting over threads of the first and second toggles in FIG. 1c after being inserted into the aperture according to some embodiments of the quick mount anchor system of the present invention.

FIG. 1e shows a final fastener assembly after the washers and the screw nut are coupled to the first and second toggles in FIG. 1d according to some embodiments of the quick mount anchor system of the present invention.

FIG. 1f shows a device, such as a searchlight, for coupling to the final fastener assembly in FIG. 1e according to some embodiments of the quick mount anchor system of the present invention.

FIG. 1g shows the searchlight coupled to the final fastener assembly in FIG. 1f according to some embodiments of the quick mount anchor system of the present invention.

FIG. 1h shows the searchlight coupled to the final fastener assembly in FIG. 1g having a protective boot arranged over the washers and the screw nut according to some embodiments of the quick mount anchor system of the present invention.

FIG. 1i shows a partial cross-sectional view of the tubing and the final fastener assembly in FIG. 1h according to some embodiments of the present invention.

FIG. 2a shows a quick mount anchor system according to some embodiments of the present invention.

FIG. 2b shows the quick mount anchor system to be inserted in the tubing according to some embodiments of the present invention.

FIG. 2c shows the quick mount anchor system inserted in the tubing in FIG. 2b having its toggle bolt tilted 90 degrees and its nut tightened for locking the toggle bolt according to some embodiments of the present invention.

FIG. 2d shows a device, such as a searchlight, for coupling to the quick mount anchor system according to some embodiments of the present invention.

FIG. 2e shows the searchlight coupled to the quick mount anchor system in FIG. 2d according to some embodiments of the present invention.

FIG. 2f shows the searchlight coupled to the quick mount anchor system in FIG. 1e having a protective boot arranged over the washers and the screw nut according to some embodiments of the present invention.

FIG. 2g shows a partial cross-sectional view of the tubing and the quick mount anchor system in FIG. 2f according to some embodiments of the present invention.

FIG. 2h shows a toggle bolt having a rivet or screw for coupling two toggle bolts halves together according to some embodiments the quick mount anchor system of the present invention.

### DETAILED DESCRIPTION OF THE INVENTION

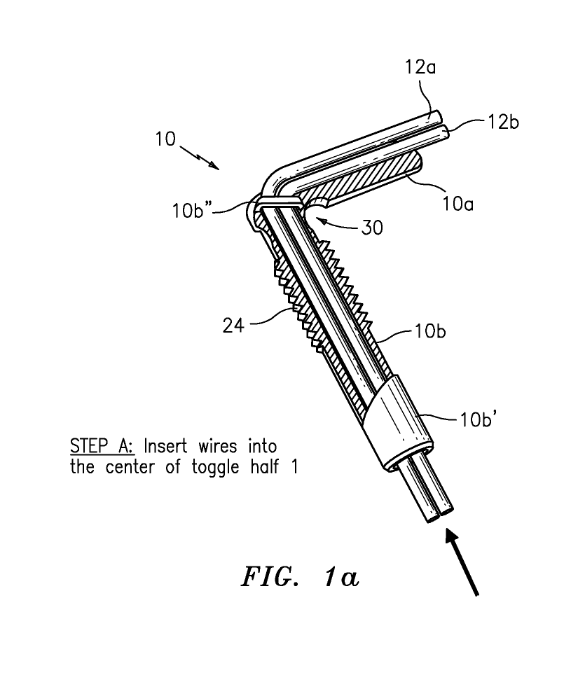

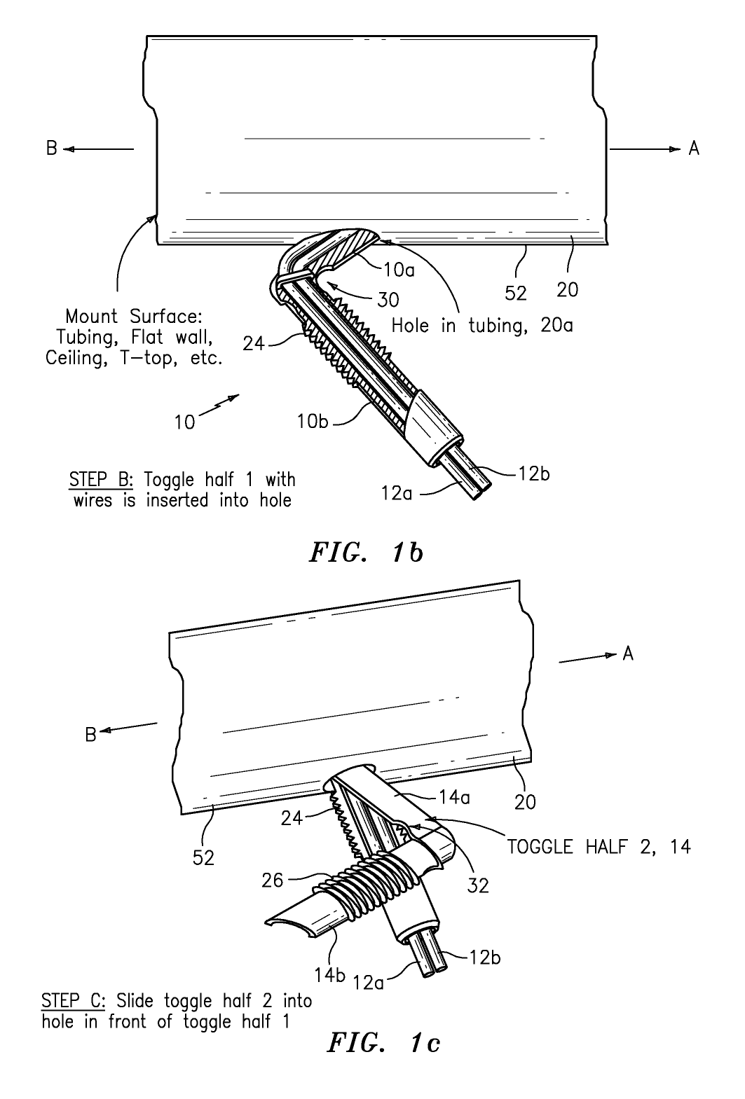

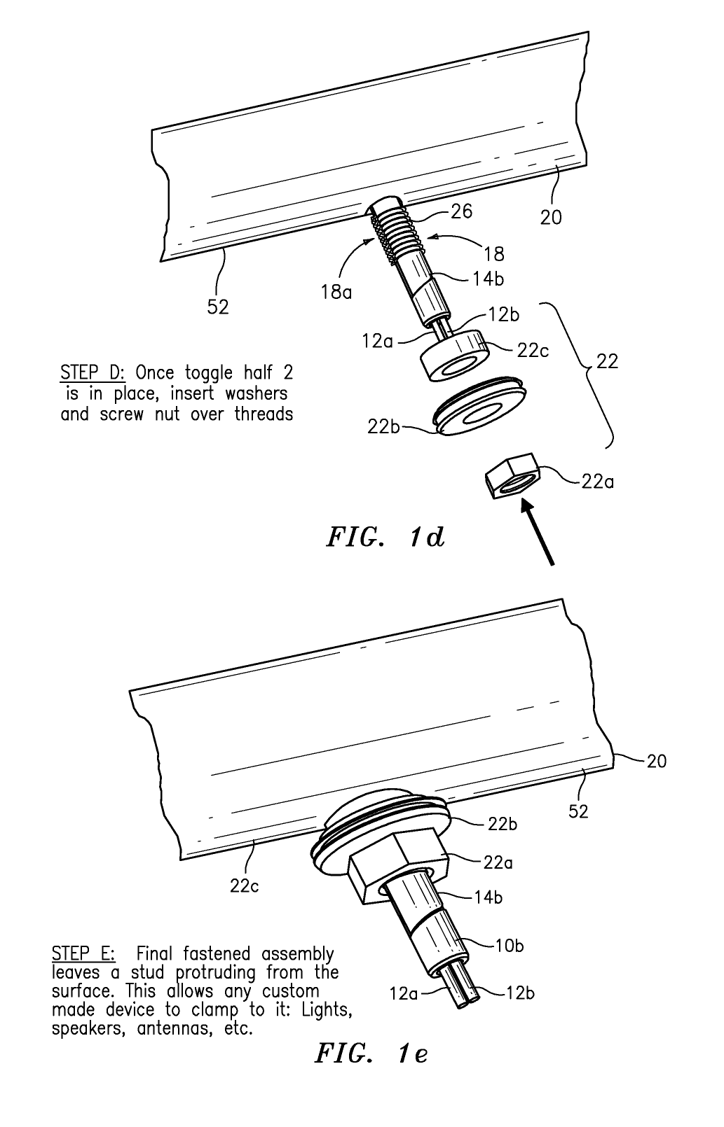

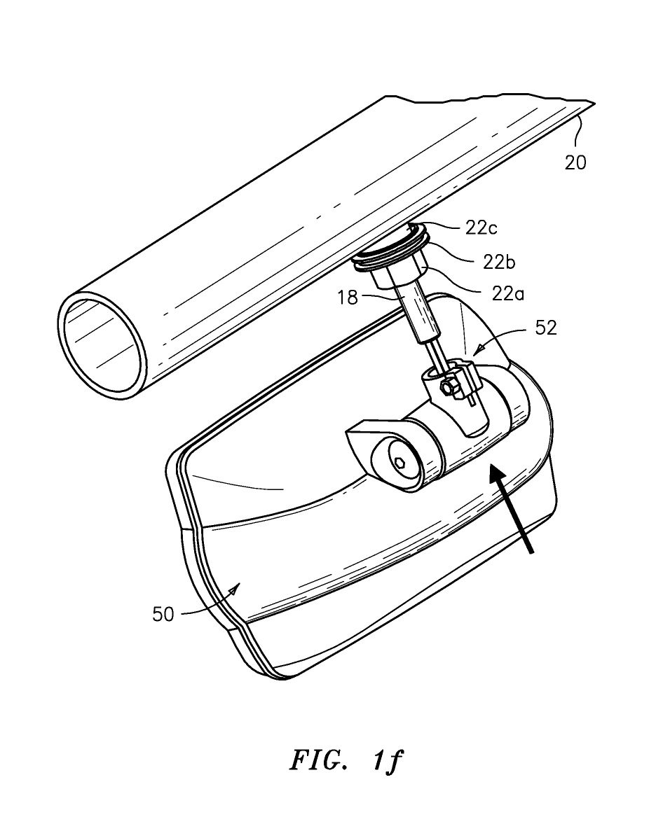

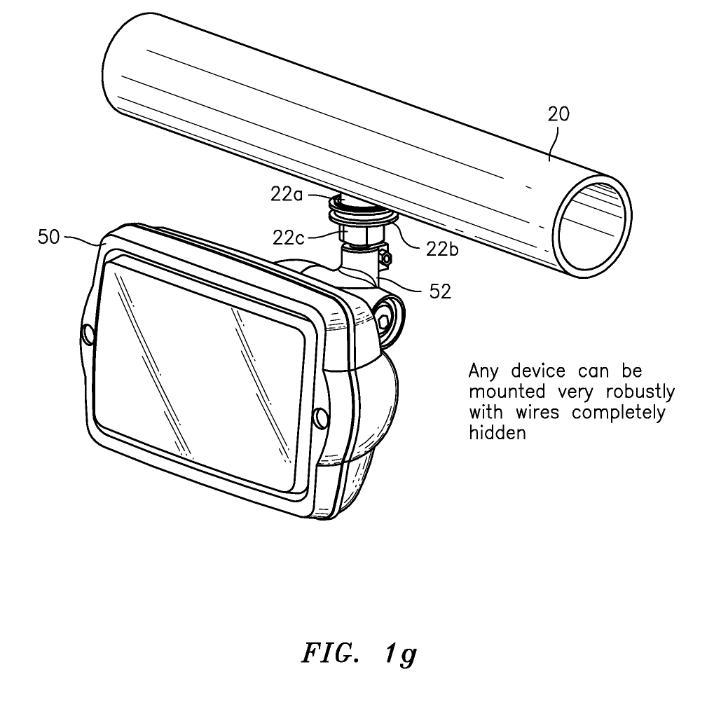

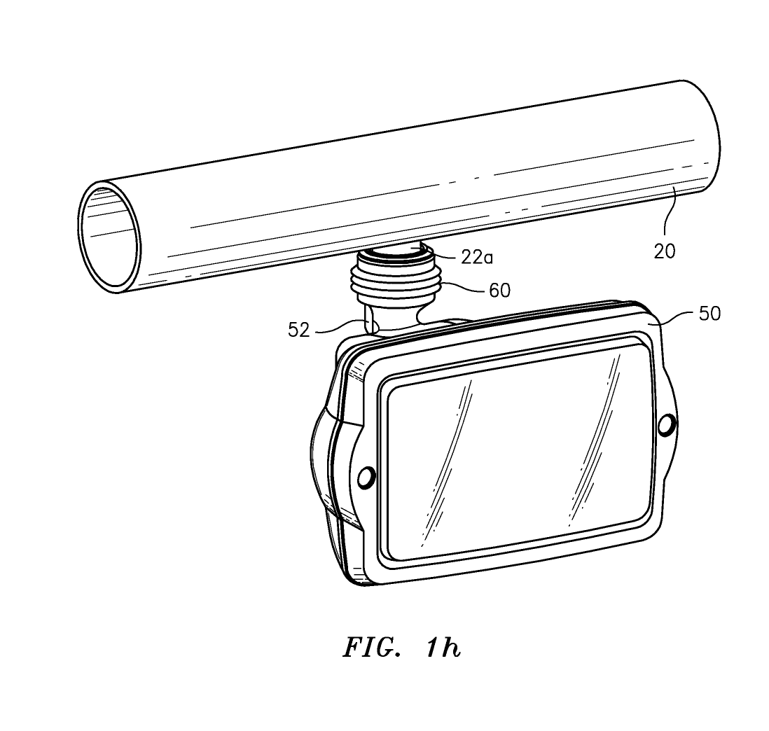

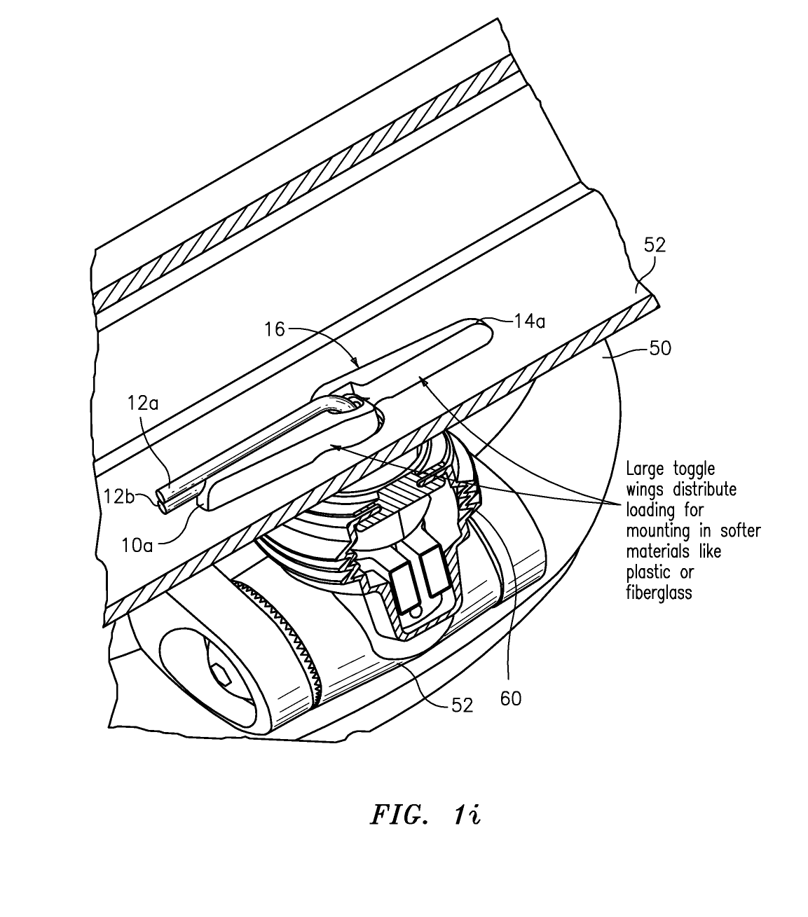

FIGS. 1a to 1i show a quick mount anchor system according to some embodiments of the present invention.

FIGS. 1a and 1b show a first L-shaped toggle half generally indicated as 10 having an L-shaped portion 10a and a stud-like portion 10b. The L-shaped portion 10a is configured to insert into an aperture 20a in a mounting surface 20 so that the L-shaped portion 10a extends in one direction generally indicated as A along the mounting surface 20. The respective stud-like portion 10b may include a partial tubular portion 10b′, an intermediate annular portion 10b″, or both for passing the one or more wires through in order to retain the same. The partial tubular portion 10b′ is configured to extend far enough so as to be able to couple a device thereto after the anchor system is mounted to the mounting surface consistent with that shown and described herein.

FIG. 1c and 1d shows a second L-shaped toggle half generally indicated as 14 having a corresponding L-shaped portion 14a and a corresponding stud-like portion 14b. The corresponding L-shaped portion 14a is configured to insert into the aperture 20a in front of the first L-shaped portion 10a so that the corresponding L-shaped portion 14a extends in another direction B along the mounting surface 20. As shown, the portions 10a, 14a extend substantially in opposite direction, although the scope of the invention is not intended to be limited to the same. The first L-shaped toggle half 10 and the second L-shaped toggle half 14 are configured to mate together so as to form an anchor system having a crosspiece portion generally indicated as 16 (see FIG. 1i) formed by the two L-shaped portions 10a, 14a on one side S1 of the mounting surface 20 and a stud portion generally indicated 18 formed by the stud-like portions 10b, 14b on the other side S2 of the mounting surface 20.

In FIG. 1d, a fastener generally indicated as 22 is configured to attach to the stud portion 18 so as to urge the crosspiece portion 16 (see FIG. 1i) against the one side S1 of the mounting surface 20 and lock the anchor system to the mounting surface 20. As shown, the fastener may include a screw nut 22a and one or more washers 22b. As shown, the stud portion 18 may take the form of a conduit having a thread portion 18a configured on its outer surface for receiving the fastener 22 that has corresponding threads (not shown) for engaging the threads 18a. In this case, each stud-like portion 10b, 14b has a respective partial threaded portion 24, 26 configured to form the threaded portion 18a when the first L-shaped toggle half 10 and the second L-shaped toggle half 14 are mated to form the anchor system.

Each L-shaped toggle half 10 and 14 may also have a respective curved portion 30, 32 where each stud-like portion 10b, 14b is respectively connected to each L-shaped portion 10a, 14a configured to facilitate inserting each L-shaped portion 10a, 14a into the aperture 20a.

By way of example, the mounting surface 20 is shown as a tubular structure, although the scope of the invention is not intended to be limited to any particular type or kind of mounting surface either now known or later developed in the future, including, but not limited to, a flat wall, a ceiling, a T-top, etc., of any structure that forms part of, e.g., a building, or a vehicle such as a marine vessel, or other apparatus, equipment, etc. either now known or later developed in the future.

FIG. 1e shows a final fastener assembly of the anchor system after the washers 22b, 22c and the screw nut 22a are coupled to the first and second toggle halves 10, 14 in FIG. 1d.

FIG. 1f shows, by way of example, a device generally indicated as 50, such as a searchlight, for coupling to the final fastener assembly of the anchor system shown in FIG. 1e. The searchlight 50 may include a coupling device 52 for clamping onto the stud 18. The scope of the invention is not intended to be limited to any particular type or kind of device for coupling to the stud portion 18, or any particular type or kind of clamping device for coupling the same together. The scope of the invention is intended to include other types or kind of clamping device either now known or later developed in the future. Further, the scope of the invention is also intended to include the stud portion 18 having further adaptations or configurations for receiving other clamping devices having corresponding adaptations or configurations now known or later developed in the future. In other words, the scope of the invention is not intended to be limited to how the device 50 and the stud portion 18 are coupled together.

As shown, the wires 12a, 12b inserted in the first L-shaped toggle half 10 may be coupled to the device 50 on one end and to some power source (not shown) on the other end to provide power to the device 50.

FIG. 1g shows the device coupled to the final fastener assembly in FIG. 1f which provides a very robust mounting configuration with the wires 12a, 12b completely and safely hidden.

FIG. 1h shows an optional protective boot 60 arranged over the washer 22b and the screw nut 22c for providing protections to these elements.

FIG. 1i shows a partial cross-sectional view of the tubing and the final fastener assembly in FIG. 1h showing the crosspiece portion inside the tubing.

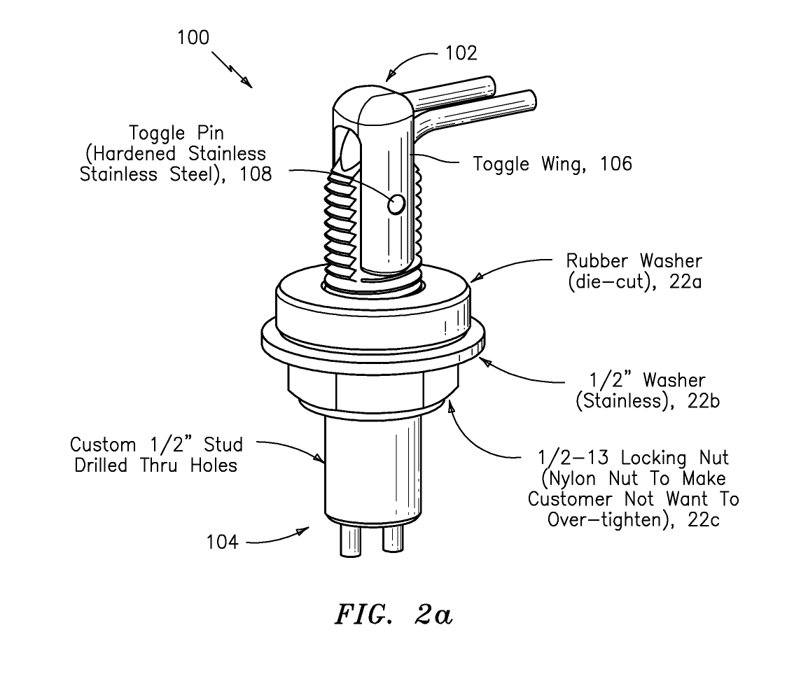

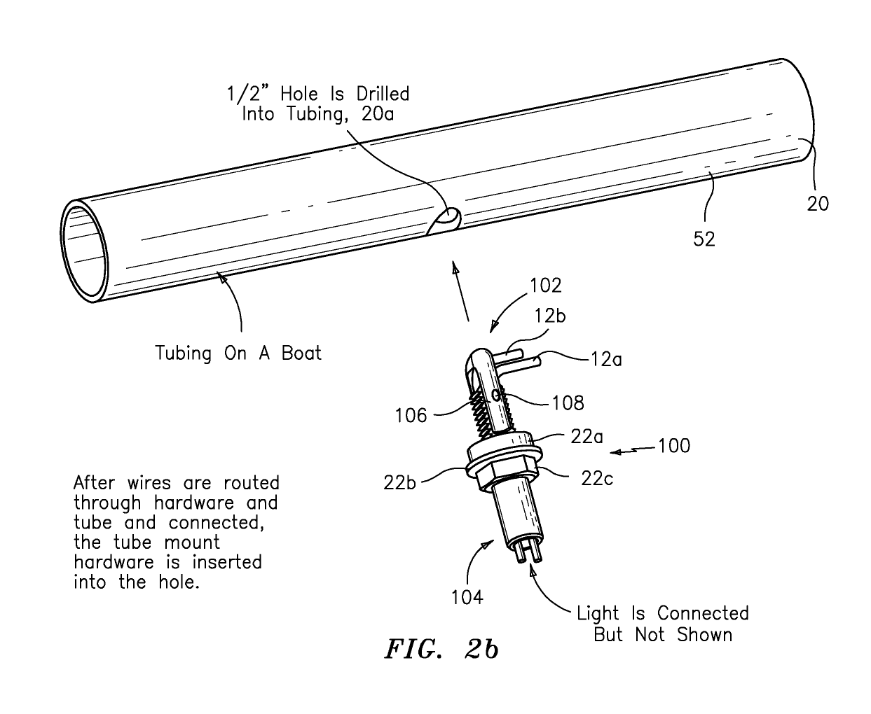

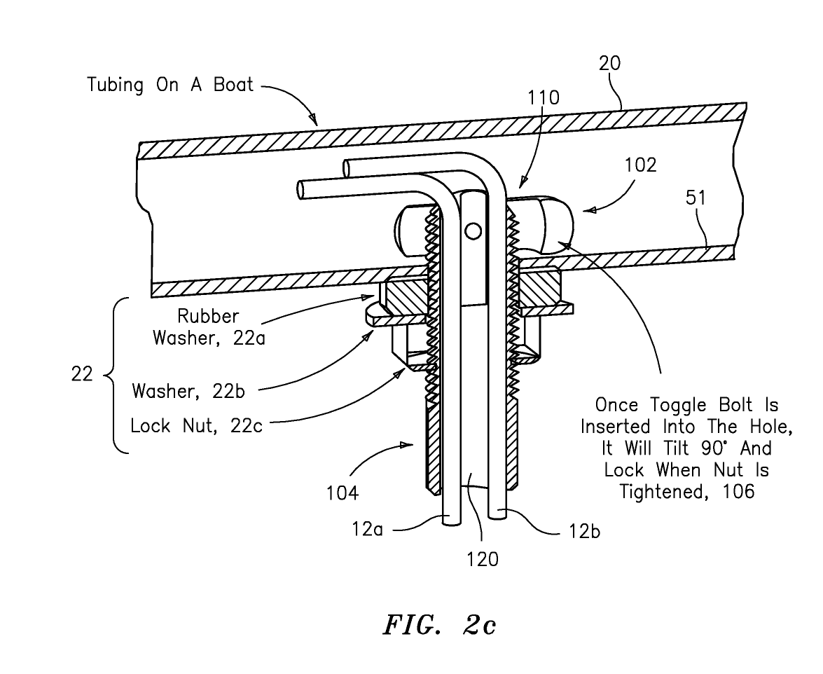

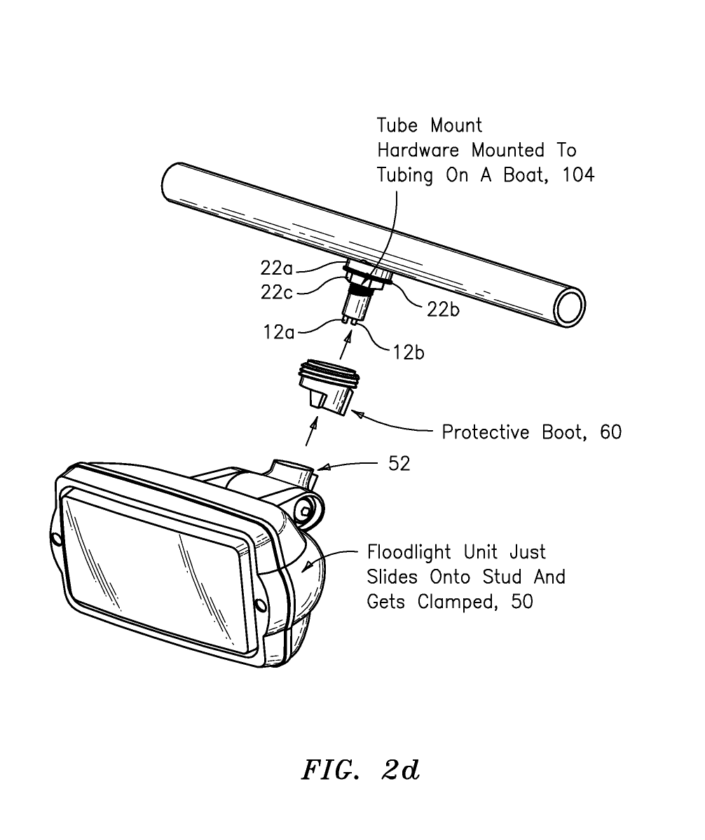

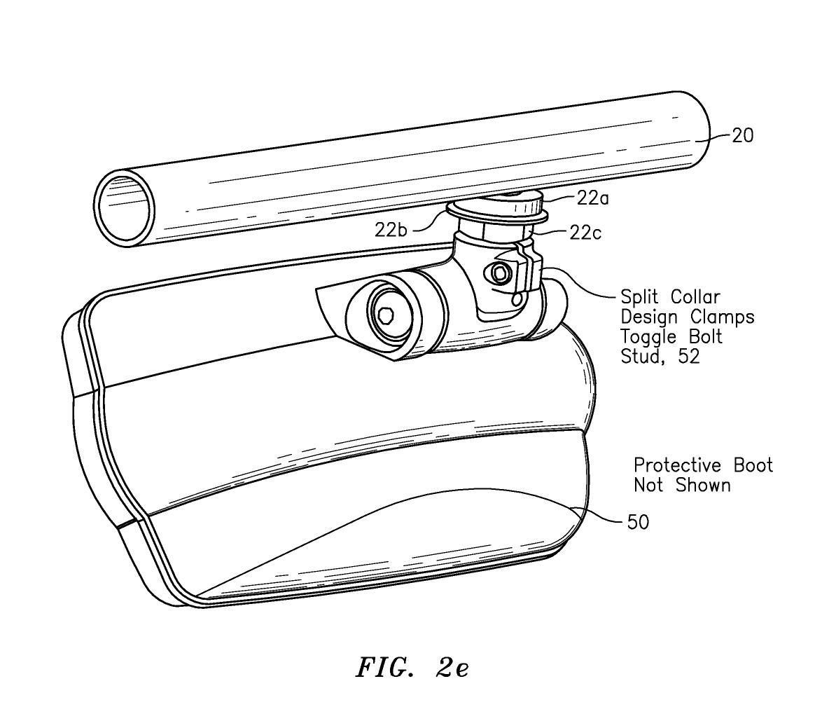

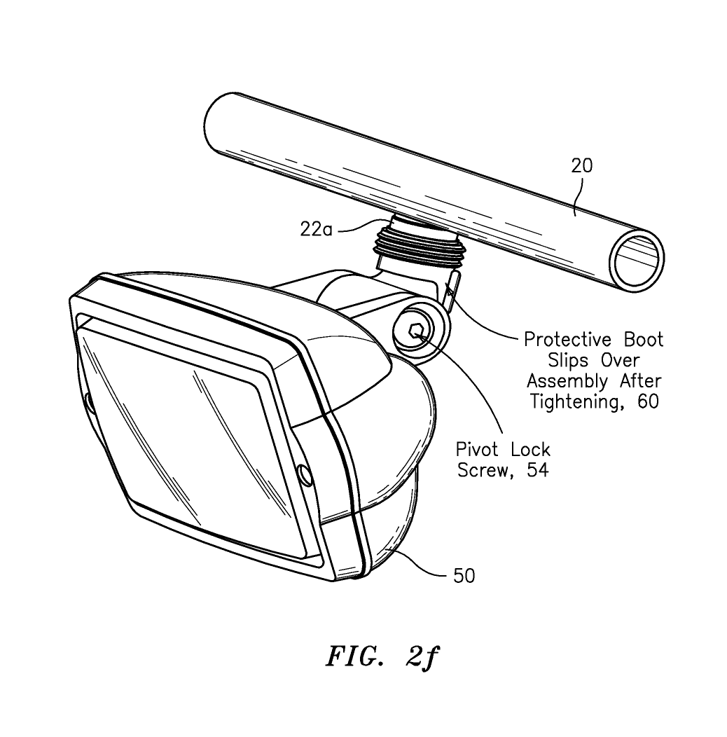

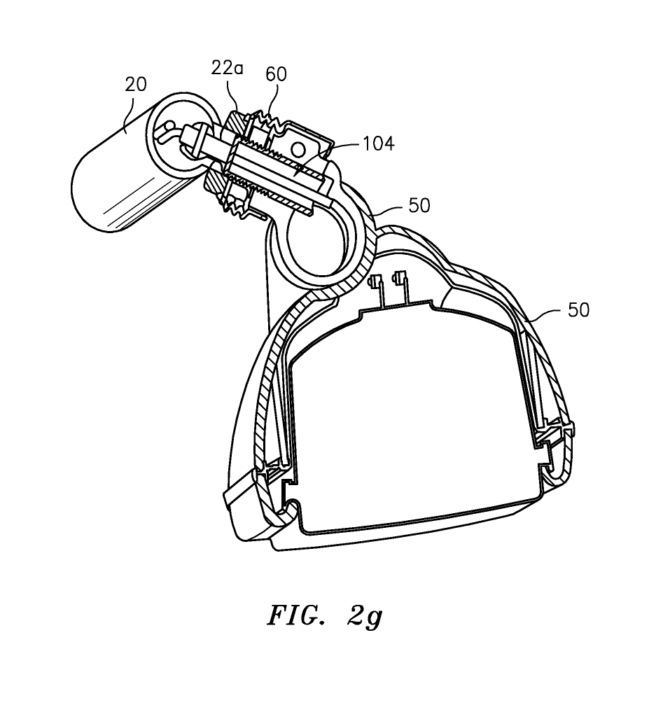

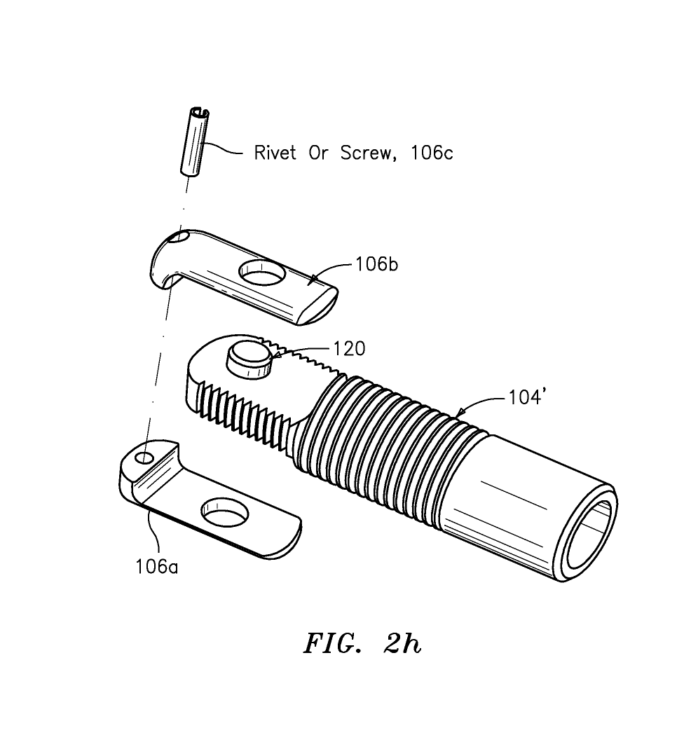

FIGS. 2a to 2h show another quick mount anchor system generally indicated as 100 according to some embodiments of the present invention. Similar parts to the embodiment shown in FIGS. 1a to 1i are references with similar reference numerals.

In FIGS. 2a, 2b, the quick mount anchor system 100 is shown to include a toggle wing portion generally indicated as 102 on one end and a stud portion generally indicated as 104 on the other end. The toggle wing portion 102 is inserted into the aperture 20a of the mounting surface 20, and has a toggle wing 106 pivotally arranged by a toggle pin 108.

In FIG. 2c, once inserted into the aperture 20a, the toggle wing rotates substantially 90° based on the disturbance related to the insertion (or some additional disturbance if needed) so that part of its longitudinal surface rests on one side S1 of the mounting surface 20 so as to form a crosspiece portion generally indicated as 110. Similar to the embodiment described above, the fastener 22 is attached to the stud portion 104 on the other side S2 of the mounting surface 20 so as to urge the crosspiece portion 110 against the mounting surface 20 and lock the anchor system to the mounting surface. Consistent with that discussed above, the stud portion 104 may include threads and the nut 22c may include corresponding threads for coupling the same together as shown. The scope of the invention is intended to include other coupling configurations either now known or later developed in the future. The toggle wing 106 is substantially pivoted at its center so as to form the crosspiece portion 110 on the one side S1 of the mounting surface once it rotates substantially 90°. As shown, the stud portion 104 is configured to form a conduit generally indicated as 120 to pass the one or more wires 12a, 12b through the mounting surface 20 for connection to some power source (not shown). The coupling device 52 may include a pivot lock screw 54 for tightening the device 50 at a particular orientation.

FIG. 22h shows an alternative embodiment where the toggle wing 106′ takes the form of two toggle wing parts 106a and 106b having a rivet or screw 106c for coupling the same together. In this embodiment, the stud portion 104′ has protrusions 120 on each side thereof for receiving the two toggle wing parts 106a and 106b.

### THE SCOPE OF THE INVENTION

It should be understood that, unless stated otherwise herein, any of the features, characteristics, alternatives or modifications described regarding a particular embodiment herein may also be applied, used, or incorporated with any other embodiment described herein. Also, the drawings herein are not drawn to scale.

Although the invention has been described and illustrated with respect to exemplary embodiments thereof, the foregoing and various other additions and omissions may be made therein and thereto without departing from the spirit and scope of the present invention.

What is claimed is:

1. An anchor system comprising:
a two-piece toggle having a crosspiece portion on one end configured to pass through an aperture in a mounting surface and engage one side of the mounting surface, and also having a stud portion on its other end configured to form a conduit to pass one or more wires through the mounting surface; and
a fastener configured to couple the stud portion to the mounting surface on an opposing side thereof so as to urge the crosspiece portion against the one side of the mounting surface and lock the anchor system to the mounting surface.

2. An anchor system according to claim 1, wherein the two-piece toggle further comprises:
a first L-shaped toggle half having a stud-like portion and an L-shaped portion configured for inserting into the aperture in the mounting surface so that the L-shaped portion extends in one direction along the mounting surface;
a second L-shaped toggle half having a corresponding stud-like portion and a corresponding L-shaped portion also configured for inserting into the aperture so that the corresponding L-shaped portion extends substantially in an opposite direction along the mounting surface; and
the first and second L-shaped toggle halves being configured for mating together so as to form the anchor system having the crosspiece portion formed by the first and second L-shaped portions on the one side of the mounting surface and having the stud portion formed by respective stud-like portions on the other side of the mounting surface extending and protruding from the aperture.

3. An anchor system according to claim 1, wherein the crosspiece portion comprises:
a toggle wing pivotally arranged on a toggle pin on the one end and configured to pass through the aperture, the crosspiece portion also having left and right toggle wing portions configured to extend in opposite directions on the one side of the mounting surface after the toggle wing is inserted in the aperture and tilts or rotates 90°.

4. An anchor system according to claim 3, wherein the toggle wing is substantially pivoted at its center so as to form the crosspiece portion on the one side of the mounting surface once it rotates substantially 90°.

5. An anchor system according to claim 1, wherein the stud portion comprises threads configured on its outer surface for receiving the fastener having corresponding threads for engaging the threads of the conduit.

6. An anchor system according to claim 1, wherein the stud portion is also configured to couple or mount a device thereto, including a light, a speaker, an antenna, etc.

7. An anchor system according to claim 1, wherein the mounting surface includes tubing, a flat wall, a ceiling or a T-top.

8. A method comprising:
inserting an L-shaped portion of a first L-shaped toggle half into an aperture in a mounting surface so that the L-shaped portion extends in one direction on one side of the mounting surface, and a stud-like portion extends from the other side of the mounting surface;
inserting a corresponding L-shaped portion of a second L-shaped toggle half into the aperture so that the corresponding L-shaped portion extends in another direction on the one side of the mounting surface, and a corresponding stud-like portion extends from the other side of the mounting surface;
mating together the second L-shaped toggle half and the first L-shaped toggle half so as to form an anchor system having a crosspiece portion formed by the two L-shaped portions on the one side of the mounting surface and a stud portion formed by respective stud-like portions on the other side of the mounting surface; and
attaching a fastener to the stud portion so as to urge the crosspiece portion against the one side of the mounting surface and lock the anchor system to the mounting surface.

9. A method according to claim 8, wherein the method comprises configuring the stud portion so as to form a conduit to pass one or more wires through the mounting surface.

10. A method according to claim 8, wherein each L-shaped toggle half is formed as an integral molded piece.

11. A method according to claim 8, wherein each L-shaped toggle half is made of plastic, aluminum, stainless steel, fiberglass, or other suitable material.

12. A method according to claim 8, wherein each stud-like portion has a respective partial threaded portion configured to form a threaded portion when the first L-shaped toggle half and the second L-shaped toggle half are mated to form the anchor system for receiving a corresponding fastener having corresponding threads.

13. A method according to claim 8, wherein the two L-shaped portions extend in substantially opposite directions.

14. A method according to claim 8, wherein the method comprises inserting one or more wires into a conduit portion of the first L-shaped toggle half before inserting the first L-shaped toggle half into the aperture for subsequently coupling to an electrical device to be mounted onto the stud portion.

15. A method according to claim 14, wherein the first L-shaped toggle half has a respective stud portion with a partial tubular portion, an intermediate annular portion, or both for passing the one or more wires through in order to retain the same.

16. A method according to claim 8, wherein each L-shaped toggle half has a respective curved portion where each stud portion is connected to each L-shaped portion configured to facilitate inserting each L-shaped portion into the aperture.

18. A method according to claim 8, wherein the method comprises inserting one or more washers onto the stud portion so as to be arranged between the fastener and the mounting surface.

19. A method according to claim 8, wherein the method comprises providing a protective boot over the fastener for sealing and protecting the mounting anchor exposed on the outside of the mounting surface.

20. A method according to claim 8, wherein the mounting surface includes tubing, a flat wall, a ceiling, a T-top or other suitable mounting surface.

21. A method according to claim 8, wherein each L-shaped toggle half has its respective stud portion connected to and extending substantially at a right angle in relation to its L-shaped portion.

22. A method comprising:
inserting one end of an anchor system having a toggle wing portion into an aperture of a mounting surface, the toggle wing portion having a toggle wing pivotally arranged by a toggle pin;
disturbing the anchor system so that the toggle wing rotates substantially 90° and part of its longitudinal surface rests on one side of the mounting surface so as to form a crosspiece portion; and
attaching a fastener to a stud portion on the other side of the mounting surface so as to urge the crosspiece portion against the mounting surface and lock the anchor system to the mounting surface.

23. A method according to claim 21, wherein the toggle wing is substantially pivoted at its center so as to form the crosspiece portion on the one side of the mounting surface once it rotates substantially 90°.

24. A method according to claim 21, wherein the stud portion is configured to form a conduit to pass one or more wires through the mounting surface.

25. A kit for providing an anchor system, comprising:
a first L-shaped toggle half having an L-shaped portion configured to insert into an aperture in a mounting surface so that the L-shaped portion extends in one direction along the mounting surface;
a second L-shaped toggle half having a corresponding L-shaped portion configured to insert into the aperture so that the corresponding L-shaped portion extends substantially in an opposite direction along the mounting surface;
the first L-shaped toggle half and the second L-shaped toggle half being configured to mate together so as to form an anchor system having a crosspiece portion formed by the two L-shaped portions on the one side of the mounting surface and a stud portion formed by respective stud-like portions on the other side of the mounting surface;
a fastener configured to attach to the stud portion so as to urge the crosspiece portion against the one side of the mounting surface and lock the anchor system to the mounting surface; and
a set of instructions for informing a purchaser of the kit how to assemble the anchor system.
